(19) United States
(12) Patent Application Publication
(10) Pub. No.: US 2010/0269929 A1
(43) Pub. Date: Oct. 28, 2010

(54) SYSTEMS OF AND METHODS FOR FLUID INTAKES AND OUTLETS THAT MINIMIZE ENVIRONMENTAL IMPACT

(76) Inventor: Donald J. Dodds, Portland, OR (US)

Correspondence Address: KOLISCH HARTWELL, P.C., 200 PACIFIC BUILDING, 520 SW YAMHILL STREET, PORTLAND, OR, 97204, US

(21) Appl. No.: 12/430,759

(22) Filed: Apr. 27, 2009

(51) Int. Cl. E03B 7/07; F03B 13/00

(52) U.S. Cl. 137/544; 290/54

(57) ABSTRACT

A hydropower system for a body of water that may comprise a fluid intake positioned below a bed of the water body and immersed in a filter below the bed, wherein fluid flows from the water body through the filter into the fluid intake. The hydropower system may further comprise a tunnel with a first end in fluid communication with the fluid intake and a second end in fluid communication with a hydropower generator, and a fluid outlet in fluid communication with the hydropower generator.

### BACKGROUND

The present disclosure relates to fluid intakes and fluid outlets that can be used in association with a hydropower generator.

Power, such as electricity, can be generated using hydropower by harnessing the gravitational force of falling or flowing water. Water flows in a body of water, such as a stream or river, both horizontally downstream and vertically either into or out of a streambed. The horizontal flow follows the stream gradient and is usually greater than the vertical flow. The gradient changes with the contour of the ground, and is most commonly steeper near the headwaters and flattens out towards the outlet. The steeper the gradient the faster the water flows.

The carrying capacity of the water body assesses the velocity of the water flow in view of the rock particles the water flow can carry. The faster the water flows the larger the particles the water body can carry. Fast flowing water may move cobbles and gravel (erosion), while slow moving water may drop all particles (deposition). Typically, the river bottom near the mouth of a river or stream is composed of silt and sand, while being composed of gravel and cobbles in the mountains. The carrying capacity, flow, and/or current may vary from water body to water body, between different sections of one water body, and from season (e.g., wet season) to season (e.g., dry season).

Both the permeability of a streambed and the water table influence the vertical flow of water into and out of the water body. The typical permeability of the natural materials of the streambed, which include a mixture of stone, sand, gravel, and/or cobble, is about 0.0003 feet per second. An influent water body is when the water table is below the streambed surface meaning that water flows out of the water body into (or through) the streambed. An influent flow may occur when the stream gradient is relatively flat or in a dry area.

An effluent water body is when the water table is above the stream surface meaning that water flows out of (or through) the streambed into the water body. An effluent flow may occur near the headwaters of the water body or in areas where water is abundant. There may be influent and effluent sections at different locations in a water body.

To harness the power generated by flowing water, either a dam system or a run-of-the river system is most commonly used. Both, however, have environmental drawbacks. For example, a dam is disruptive to the natural habitat. Moreover, the water intakes and outlets designed for either dams or run-of-the-river systems can harm or kill fish, and disrupt the natural fish habitat and spawning grounds.

Fish instinctively swim with horizontally moving currents. The standard head works design for a dam generally includes an opening in a body of water to capture and transfer water to a turbine. The opening of the intake is typically located directly in the water body such that the intake receives water flowing substantially horizontally and at a high velocity. The velocity, for example, may be 100 feet per second. In the standard dam design, the smolt will instinctively swim with the horizontal flow into the intakes of dams, and some are then either injured or killed by hydropower turbine blades. While most dams have a barrier designed to prevent this situation from occurring, these barriers are not completely successful and large numbers of migrating fish are still injured or killed in hydropower turbines.

Also, the water intake for a run-of-the-river system is typically placed directly into the water body such that the intake receives water flowing substantially horizontally at a high velocity. As such, fish are attracted to this type of flowing water and are injured or killed when sucked through the intake into the hydropower system. Whereas the water intake may be covered with a fine mesh screen to exclude fish, such a screen does not effectively prevent smolt damage and is not as environmentally friendly as the natural materials, i.e. gravel or cobbles, found in the streambed. Covering the water intake with a mesh screen also means that the intake is still located in the river where the intake can clog with debris or interfere with other river activities, such as boating or swimming, and with the natural habitat.

### SUMMARY

A hydropower system for a body of water that may comprise a fluid intake positioned below a bed of the water body and immersed in a filter below the bed, wherein fluid flows from the water body through the filter into the fluid intake. The hydropower system may further comprise a tunnel with a first end in fluid communication with the fluid intake and a second end in fluid communication with a hydropower generator, and a fluid outlet in fluid communication with the hydropower generator.

### BRIEF DESCRIPTION OF THE DRAWINGS

FIG. 1 is a schematic Illustration of a hydropower system comprising a fluid intake and a fluid outlet.

FIG. 2 is a side view of an embodiment of a fluid intake.

FIG. 3 is a top view of the embodiment of the fluid intake of FIG. 2.

FIG. 4 is a side view of another embodiment of a fluid intake.

FIG. 5 is a top view of the embodiment of the fluid intake of FIG. 4.

FIG. 6 is a side view of an embodiment of the fluid outlet.

FIG. 7 is a top view of the embodiment of the fluid outlet of FIG. 6.

### DETAILED DESCRIPTION

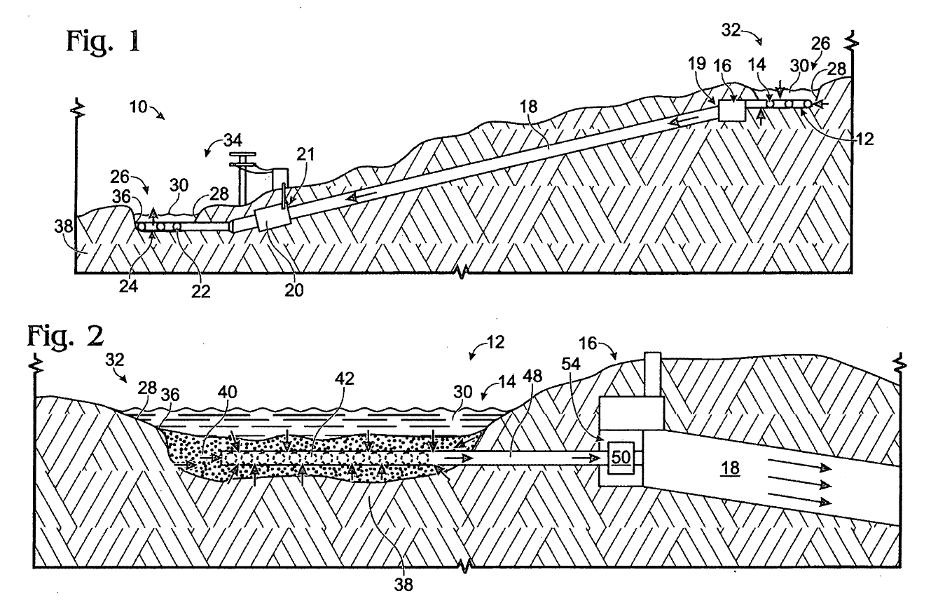

FIG. 1 depicts a hydropower system 10 that may comprise a first filter 12, a fluid intake 14, a head works 16, a tunnel 18, a hydropower generator 20, a fluid outlet 22, and a second filter 24.

Hydropower system 10 is designed to generate power from a body of water 26, such as a river or stream. Water body 26 may form a channel 28 in which fluid 30 (e.g., water) flows with a current, such as between an upstream point 32 and a downstream point 34. Below a bottom or bed 36 of channel 28 is a streambed 38 that consists of naturally occurring materials such as stone, sand, gravel, and cobble. An underground water table may also exist in, and flow through, streambed 38. The underground water table may be in fluid communication with channel 28 via streambed 38. Hydropower system 10 may be interconnected such that fluid 30 from channel 28 of water body 26 and/or from an underground water table in streambed 38 at upstream point 32 may flow through first filter 12 into fluid intake 14 into head works 16 into tunnel 18 into hydropower generator 20 and exit at downstream point 34 into fluid outlet 22 through second filter 24 into channel 28 of water body 26. Black arrows are used throughout FIGS. 1 through 7 to indicate the direction of flow of fluid. The flow of fluid 30 though hydropower system 10 may be used by hydropower generator 20 to generate power or electricity. Upstream point 32 may be located at or near an effluent portion of water body 26. Upstream point 32 and downstream point 34 may be in the same body of water, or in different bodies of water. Downstream point 34 may also be a manmade or naturally occurring lake, pool, or drain.

First filter 12 and fluid intake 14 are located beneath or below bottom or bed 36. First filter 12 and fluid intake 14 may be positioned at or near upstream point 32. First filter 12 may be located between channel 28 and fluid intake 14 beneath bottom or bed 36 such that fluid 30 in channel 28 flows through first filter 12 into fluid intake 14. A portion of streambed 38 beneath bottom or bed 36 may be excavated or removed and first filter 12 and fluid intake 14 may occupy the excavated area. First filter 12 may be located between streambed 38 and fluid intake 14 such that fluid from the underground water table of streambed 38 flows through first filter 12 into fluid intake 14.

As indicated by the black arrows in FIG. 1, first filter 12 may control the flow or water table in streambed 38. Fluid 30 from channel 28 may flow substantially vertically (i.e., substantially perpendicular) relative to the current or flow of fluid 30 in channel 28 into first filter 12.

First filter 12 comprises a material that may be selected based on the permeability and porosity properties of the material. To achieve a desired flow and/or velocity through first filter 12, the permeability and/or porosity of first filter 12 may be manipulated, as may the area and/or size of filter 12. The permeability of first filter 12 may be higher than the permeability of the surrounding streambed 38 around (or in) which first filter 12 and fluid intake 14 are situated. First filter 12 also may provide a barrier through which fish cannot swim into fluid intake 14. The material of filter 12 may therefore comprise any combination of sand, gravel, cobble, porous fabric, metal, filter blankets and/or concrete screens. These materials may be mixed or layered as desired.

Fluid intake 14 may be completely or partially immersed within, or surrounded by, first filter 12 beneath bottom or bed 36. Fluid intake 14 may receive fluid from channel 28, the underground water table of streambed 38, or any fluid source. Fluid intake 14 may be in fluid communication with head works 16 and/or tunnel 18. Head works 16 may be adapted to control the velocity and/or flow of fluid into fluid intake 14, and between fluid intake 14 and tunnel 18. Head works 16 may contain gauges for monitoring the current or flow of fluid 30 in channel 28. Head works 16 may contain gauges and valves to monitor and regulate the flow and/or velocity of fluid through first filter 12, fluid intake 14, tunnel 18, hydropower generator 20, fluid outlet 22, and/or second filter 24. Head works 16 may include a gauging station for automatically controlling the flow and/or velocity of fluid into first filter 12 and/or fluid intake 14 based on changes in the flow or current of fluid 30 in channel 28. Fluid intake 14 may be in fluid communication with tunnel 18 through one or more pipes.

The desired flow or velocity of fluid into fluid intake 14 may be based on the desired amount of energy that will be generated by hydropower generator 20. The flow or velocity into fluid intake 14 (and/or first filter 12) may be controlled by manipulating the porosity and permeability of first filter 12; the surface area (both length and width) and/or size of first filter 12 and/or fluid intake 14; the placement of filter 12 and/or fluid intake 14 relative to each other and/or relative to water body 26 and/or relative to the underground water table; and/or using flow controls (e.g., valves). Correct manipulation of these parameters may produce a fluid intake 14 that can extract a larger volume of fluid from the underground water table than from a fluid intake located in channel 28.

Once positioned beneath bottom or bed 36 of water body 26, first filter 12 and fluid intake 14 may not be visible from the ground, and also may not interfere with activities such as swimming or boating in water body 26, because each may be located below (and not in) channel 28. One or more sets of first filters 12 and fluid intakes 14 may be used in combination, if desired. A single fluid intake 14 may be in fluid communication with one or more first filters 12 and a single first filter 12 may be in fluid communication with one or more fluid intakes 14.

Tunnel 18 may have a first end 19 and a second end 21. First end 19 may be positioned near upstream point 32 of water body 26 and in fluid communication with fluid intake 14 and/or head works 16 (e.g. through pipes). Second end 21 may be positioned near downstream point 34 and in fluid communication with fluid outlet 22. (e.g. though pipes). First end 19 may be positioned at a higher elevation than second end 21. Tunnel 18 may be of any desired diameter and length. In some embodiments, the diameter of tunnel 18 may be about or greater than 30 feet. In some embodiments, the length of tunnel 18 between first end 19 and second end 21 may be about or greater than 8 miles. The height, length, and diameter parameters of tunnel 18 may all be manipulated and determined by the amount of desired energy output from hydropower generator 20. The flow of fluid through tunnel 18 for generating power using hydropower generator 20 may (but not must) be about 5 to about 7,500 cubic feet per second. It will be appreciated that any fluid conveyance structure may be used instead of (or in addition to) tunnel 18, including one or more tunnels, pipes, canals, flumes, or any other suitable structure that can direct fluid. It will also be appreciated that any, all and/or sections of hydropower system 10 may be in fluid communication using one or more interconnected fluid conveyance structures, in any combination desired.

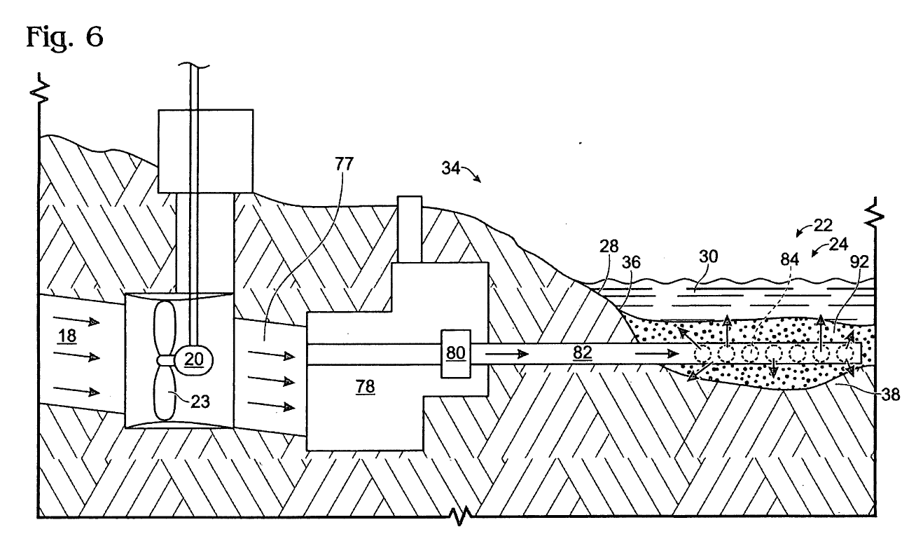

Hydropower generator 20 may be configured as would any hydropower generator used to generate power or electricity, such as including a turbine 23 (see FIG. 6) that is rotated or turned by flowing fluid.

As shown in FIG. 1, a fluid outlet 22 and a second filter 24 may be used to disseminate water from hydropower system 10. Fluid outlet 22 and second filter 24 may be configured in a similar manner as fluid intake 14 and first filter 12, except that fluid flows or exits from fluid outlet 22 through second filter 24 into channel 28 of water body 26 and/or into streambed 38. Fluid outlet 22 may be used to reintroduce water at a downstream point 34 into water body 26 (or into another area or body of water) after the fluid leaves hydropower generator 20. As with first filter 12 and fluid intake 14, fluid outlet 20 and second filter 22 may be beneath bottom 36 of water body 26 (and not in water body 26) so as not to be visible or interfere with activities such as boating or swimming.

Fluid may flow through second filter 24 into channel 28 of water body 26 substantially vertically relative to the current (or flow) of fluid 30 in channel 28. Fluid outlet 22 and second filter 24 may be configured to disseminate the full flow of fluid exiting from hydropower generator 20. Fish may spawn in an area where fluid is flowing through bottom or bed 36 into channel 28 at a sufficient and substantially constant rate, and substantially vertically relative to the flow or current of fluid 30 in channel 28. Second filter 24 may be adapted to encourage the spawning of fish on or around second filter 24 by introducing fluid flowing into channel 28 at a substantially constant rate of velocity and/or flow, and substantially vertically relative to the flow or current of fluid 30 in water body 26.

Because the flow of fluid from fluid outlet 22 into second filter 24 may be varied depending on the volume and/or flow of fluid exiting from hydropower generator 20 (which may vary as the desired power output may vary), a separate fluid source may be in fluid communication with second filter 24 to maintain a substantially constant flow and/or velocity of fluid from second filter 24 into channel 28. For example a separate first filter 12 and fluid intake 14 not connected (though it may be) to hydropower generator 20 may be in fluid communication with second filter 24 to maintain the desired substantially constant rate of flow and/or velocity from second filter 24 into channel 28. Automatic and/or manual gauges and/or valves may be included to regulate and maintain the substantially constant rate of flow and/or velocity of fluid through second filter 24 into water body 26. These gauges and valves may also be used to control the volume of fluid directed through second filter 24 from fluid outlet 22 and/or other fluid sources and/or between various fluid sources in fluid communication with second filter 24.

One or more sets of fluid outlets 22 and second filters 24 may be used in combination, if desired. A single fluid outlet 22 may also be used with one or more second filters 24 and a single second filter 24 may be used with one or more fluid outlets 22.

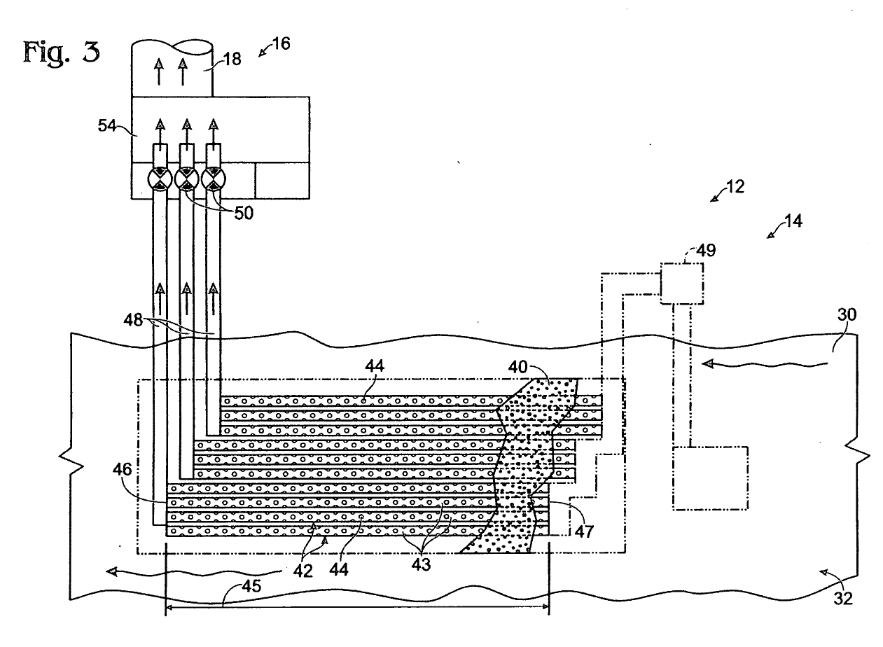

FIGS. 2 and 3 depict an illustrative embodiment of first filter 12, fluid intake 14, and head works 16. In this embodiment, first filter 12 comprises a permeable material 40. Fluid intake 14 may be covered by, encapsulated by, and/or immersed in, permeable material 40. Fluid intake 14 and permeable material 40 may both be located beneath bottom 38 of channel 28. When so situated beneath bottom 38, permeable filter 40 allows fluid communication between fluid intake 14 and fluid 30 of channel 28. Permeable material 40 may create a barrier that prevents fish from swimming into fluid intake 14. Because fluid 30 may be drawn substantially vertically at a low velocity from channel 28 into permeable material 40, fish should not generally be attracted to fluid intake 14. Permeable filter 40 may allow fluid communication between fluid intake 14 and fluid in the underground water table of streambed 38. It will be appreciated that fluid intake 14, if desired, may be partially immersed in permeable material 40 such that a portion of fluid intake 14 is exposed to streambed 38 and/or to channel 28.

Permeable material 40 may be comprised of course sand and/or fine gravel that allows fluid to flow at a velocity of about 1 foot per second, more or less, through first filter 12, or at any desired flow and/or velocity. In some embodiments, a velocity of about 0.3 feet per second through first filter 12 may be desired. Permeable material 40 may be adapted to allow fluid to flow into fluid intake 14 from first filter 12 at different velocities in different areas of first filter 12. For example, the composition of permeable material 40 may be adapted to allow a velocity of about 0.3 feet per second of fluid 30 from channel 28 through first filter 12, but be adapted by changing the composition to allow fluid from the underground water table of streambed 38 to flow through first filter 12 at a different velocity (though it may be the same velocity as well).

The embodiment of fluid intake 14 in FIGS. 2 and 3 may comprise at least one pipe 42 having a surface 43 with perforations 44, and a length 45 between a downstream end 46 and an upstream end 47. Any desired number of pipes 42 may be used in series. In some embodiments, such as the one depicted in FIG. 3, a series of pipes 42 may be positioned in parallel beneath bottom or bed 36 of water body 26 so that length 45 of each pipe is positioned substantially parallel with the current of fluid 30 in channel 28. Pipe or pipes 42 may be positioned in any way desired, and each pipe 42 may be positioned different from the other pipes 42 in the series. Pipe or pipes 42 may be constructed of any material desired, such as aluminum or steel. Length 45 of each pipe 42 in FIG. 3 may be about 1000 feet in length, more or less. Length 45 of each pipe 42 may be the same or different. More than one series of pipes 42 may be incorporated into hydropower system 10 if desired. All the pipe parameters (i.e., length, size, diameter, etc.) may be manipulated to achieve a desired flow and/or velocity of fluid into pipe or pipes 42.

Perforations 44 allow fluid into each pipe 42. Perforations 44 may be located around the entire surface 43, or only on a portion of surface 43 (e.g., only on a top or bottom portion, or only on a section of the top or bottom portion). Each pipe 42 in a series of pipes 42 may have the same or different configurations of perforations 44 on surface 43. In the embodiment of FIGS. 2 and 3, the flow rate of fluid into each of the ten pipes 42 may be about 100 cubic feet per second, but the flow rate may be any rate desired.

Upstream end 47 may be positioned at a higher elevation or gradient than downstream end 46 to aid the flow of fluid in pipe or pipes 42 toward downstream end 46. Each or either of ends 46, 47 may be perforated or open.

Pipe or pipes 42 may be in fluid communication with one or more collector pipes 48 and a backwash 49. It will be appreciated that back wash 49 may be any design that is adapted to rinse, clean, and/or unclog debris or dirt from first filter 12 and/or fluid intake 14.

Collector pipe or pipes 48 may be connected for fluid communication at downstream end 46 of pipe or pipes 42, but may be fluidly connected anywhere to pipe or pipes 42 as desired. Collector pipe or pipes 48 may be any desired collector pipes design, such as a design that includes a pipe or series of pipes that fluidly connect pipe or pipes 42 to tunnel 18. In some embodiments, the flow rate through collector pipe or pipes 48 from fluid intake 14 may be about 1000 cubic feet per second, but may be any flow rate desired.

Collector pipe or pipes 48 may include one or more valves 50 that are adapted to regulate the flow of water between pipes 42 and tunnel 18 and/or other fluidly connected components of hydropower system 10. It will be appreciated that valves 50 may be for manual shut-off or regulation of fluid, or may employ a system using automatic equipment and electronics to regulate flow. One or move valves 50 may be placed at any desired location in hydropower system 10 to regulate flow at different intervals, and valves 50 may be located at more than one location.

As shown in FIG. 3, collector pipe or pipes 48 may be connected to, and in fluid communication with, tunnel 18. Part of collector pipe or pipes 48 may be housed within a collection gallery 54. Collection gallery 54 may be part of head works 16. Valves 50 or other equipment to control water flow may be housed within collection gallery 54 of head works 16.

To install the embodiment of FIGS. 2 and 3, fluid 30 in channel 28 may be diverted away from bottom or bed 36 at or near upstream point 32. An area beneath bottom or bed 36 of channel 28 may be excavated or removed. Pipe or pipes 42 of fluid intake 14 may be installed in the excavated or removed area. Pipe or pipes 42 may be placed in series (as shown in FIG. 3) positioned parallel to a flow or current of fluid 30 in channel 28. Fluid intake 14 may be fluidly connected to collector pipe or pipes 48 and to hydropower system 10. The remainder of the excavated or removed area may be filled with permeable material 40 of first filter 12 that is of a desired permeability and porosity. Permeable material 40 may be manufactured such that it controls the flow or velocity of fluid into pipe or pipes 42 from channel 28 of water body 26 and/or the underground water table of streambed 38. A portion of permeable material 40 may first be filled into the excavated area, followed by pipes 42 being positioned in the excavated area, followed by another portion of permeable material 40 being filled over pipes 42.

In operation, gravity may pull fluid 30 flowing substantially vertically from channel 28 through permeable material 40 into pipe or pipes 42. Fluid from the underground water table may flow through permeable material 40 into pipe or pipes 42. Fluid 30 may flow from pipe or pipes 42 into collector pipe or pipes 48. Valves 50 may be used to control or regulate the flow of fluid between pipe or pipes 42, collector pipe or pipes 48, and/or tunnel 18. Fluid or water flowing into tunnel 18 may be used to generate power or electricity using hydropower generator 20.

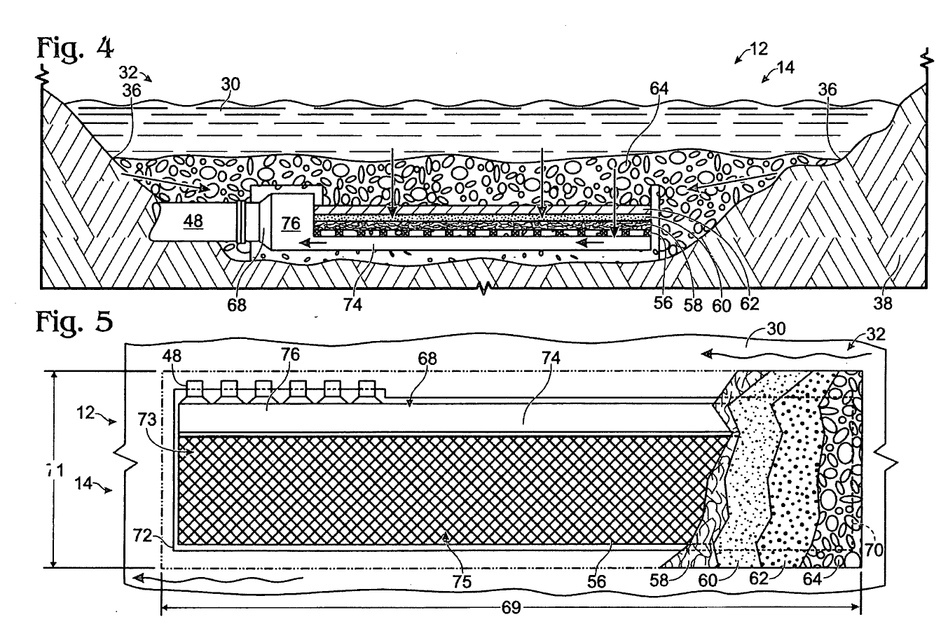

FIGS. 4 and 5 depict another illustrative embodiment of first filter 12 and fluid intake 14. The other components of the embodiment of hydropower system 10 depicted in FIGS. 4 and 5 may be configured and operated in the same manner as described above.

First filter 12 may be comprised of a support structure 56, a filter blanket layer 58, and filter layers 60, 62, 64. Filter 12 may be stacked or layered on support structure 56, which may be positioned over fluid intake 14, starting with filter blanket layer 58 followed by filter layers 60, 62, 64. Support structure 56 may contain any pattern, such as a grid, that allows fluid to pass into fluid intake 14 while also supporting the layers stacked on support structure 56. Support structure 56 may be a gridded steel grate, but may be constructed of any material that is desired.

Filter blanket layer 58 may be any type of filter blanket desired, such as sand, gravel, or a plastic blanket. Filter blanket layer 58 may be adapted to prevent or inhibit silt, clay and/or dirt from entering fluid intake 14. Filter blanket 58 may be permeable so as to allow fluid to pass through filter blanket 58 into fluid intake 14. Filter blanket layer 58 may be less permeable than filter layer 60, which may be less permeable than filter layer 62, which may be less permeable than filter layer 64.

Filter layer 60 may be comprised of sand, gravel, or cobbles. Filter layer 62 may be a sand, gravel, or cobble layer having a larger porosity and larger pores than filter layer 60. Filter layer 64 may be a course river run gravel having a larger porosity and larger pores than filter layers 60 and 62. The difference in porosity and pore sizes may prevent filter layers 60, 62, 64 from co-mixing or co-mingling. Filter layer 64 may resemble streambed 38 to give the appearance of a natural bottom or bed 36 of channel 28. The coarse river run gravel of filter layer 64 may contain grain sizes of about ¼ inch, and up to 6 to 8 inches in diameter.

First filter 12 may be configured with the various materials to achieve the desired permeability to control the flow or velocity of fluid into fluid intake 14 from channel 28 and/or from the underground water table of streambed 38. Any number of layers of filter material, and any combination of materials for those layers, may be used to achieve the desired flow and/or velocity of fluid through first filter 12 into fluid intake 14. One or more layers of filter material may be used to achieve a desired permeability or porosity of first filter 12. It will be appreciated that more or less layers of filtering material may be used in first filter 12 as desired to control the flow or velocity of fluid into fluid intake 14. Natural (e.g. sand, gravel, cobble, etc.) or synthetic (e.g. filter blanket) filtering materials may be used.

As best seen in FIG. 5, fluid intake 14 may be a container 68 having an upstream side 70 and a downstream side 72 forming an open top 73, and also having a raceway 74, a cavity 75 underneath open top 73, and a catch basin 76 positioned near downstream side 72. As shown in FIG. 4, the filter layers of first filter 12 and container 68 may be buried and/or positioned beneath bottom or bed 36 of channel 28. Container 68 may be made of concrete, or any other material that is suitable and desired. Container 68 may have a length 69 of about 250 feet and a width 71 of about 40 feet. Upstream side 70 may be at a higher elevation and/or gradient than downstream side 72.

Raceway 74 may be in fluid communication with cavity 75 and/or catch basin 76. Catch basis 76 may be in fluid communication with collector pipe or pipes 48. Collector pipe or pipes 48 may be adapted to direct fluid from catch basin 76 underneath bottom or bed 36 to a hydropower generator 20 as described above.

To install the embodiment of FIGS. 4 and 5, fluid 30 of channel 28 may be diverted from an upstream point 32. An area of streambed 38 beneath bottom or bed 36 of channel 28 may be excavated or removed at upstream point 32. The excavated or removed area from streambed 38 may be processed to separate the sand, cobble, gravel and other materials. Container 68 may be positioned into the excavated or removed area, and covered by support structure 56, filter blanket 58, and filter layers 60, 62, 64. One or more collector pipes 48 may be connected in fluid communication with catch basin 76 near downstream side 72. The remaining components of hydropower system 10 may be configured as described above.

In operation, gravity may pull fluid 30 substantially vertically from channel 28 through filter layer 64 into filter layer 62 into filter layer 60 into filter blanket layer 58 through support structure 58 through open top 34 into cavity 35. Fluid may flow from cavity 75 into raceway 74 towards catch basin 76 near downstream side 72. Fluid may flow from catch basin 76 into one or more collector pipes 48. The other components (e.g. head works 16, tunnel 18, hydropower 20, etc.) of FIGS. 4 and 5 may otherwise be configured and operate in the manner described above. In some embodiments, fluid may flow directly from cavity 35 and/or raceway 74 into collector pipe or pipes 48.

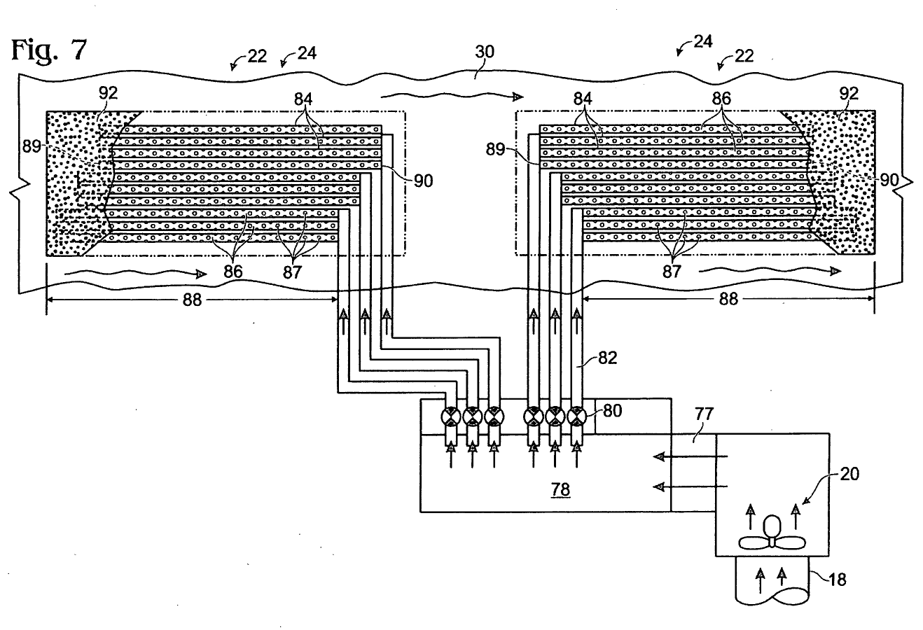

FIGS. 6 and 7 depict an illustrative embodiment of fluid outlet 22 and second filter 24, which may be used to disseminate fluid from hydropower generator 20. Hydropower generator 20 may be connected in fluid communication with a pipe 77 and a collection gallery 78 that houses one or more valves 80 and a portion of collector pipes 82. Valves 80 (which may be similar to valves 50) may be used to regulate the flow of fluid between hydropower generator 20 and collector pipes 82, which are fluidly connected (either directly, or through a series of pipes, such as pipes 77).

The embodiments of fluid outlet 22 and second filter 24 depicted in FIG. 6 may be respectively structured and configured similar to the embodiments of fluid intake 14 and first filter 12 depicted in FIGS. 2 and 3. For example, as may fluid intake 14 depicted in FIGS. 2 and 3, fluid outlet 22 depicted in FIG. 6 may have one or more pipes 84 having a surface 86 with perforations 87, and a length 88 between an upstream end 89 and a downstream end 90. Pipes 84 may be similarly configured as pipes 42. One or more pipes 42 may be installed in a series where length 88 is laid parallel to the flow or current of fluid 30 in channel 28. Collector pipes 82 may be connected in fluid communication with either upstream end 89 or downstream end 90, as desired.

Second filter 24 may be comprised of one or more permeable materials 92 described above (e.g., sand, cobble, gravel, course river run gravel, etc.) and configured to introduce fluid substantially vertically into channel 28 from fluid outlet 22 through second filter 24. Second filter 24 may be configured (such as by using course river run gravel as one of permeable materials 92) to encourage fish to spawn on or near bottom or bed 36 and/or on or near second filter 24. It will be appreciated that the embodiments of fluid outlet 22 and second filter 24 depicted in FIGS. 6 and 7 may be installed beneath bottom 36 at downstream point 34 in the same manner as described above for the embodiments of first filter 12 and fluid intake 14 depicted in FIGS. 2 and 3.

In operation, after fluid flows through tunnel 18 to power hydropower generator 20, the fluid may exit towards collection gallery 78 through collector pipes 82 through fluid outlet 22 through second filter 24 into channel 28 and/or streambed 38. Fluid may flow at a substantially constant rate substantially vertically through second filter 22 into channel 28.

A similar structure and configuration to the embodiments of fluid intake 12 and/or first filter 14 depicted in FIGS. 4 and 5 may also be installed and used respectively as fluid outlet 22 and second filter 24 to introduce fluid substantially vertically and/or at a substantially constant rate into channel 28 through second filter 24 from fluid outlet 22.

It will be appreciated that each of the embodiments described above may be used in combination with each other. For example, the embodiment of fluid inlet 12 depicted in FIGS. 2 and 3 could be used with the embodiment of first filter 14 depicted in FIGS. 4 and 5. The embodiment of first filter 14 depicted in FIGS. 2 and 3 could be used with the embodiment of fluid inlet 12 depicted in FIGS. 4 and 5. Any of the first filters 14 depicted herein may be configured as second filters 24, and any of the fluid inlets 12 may be configured as fluid outlets 22, or vice versa.

It will be appreciated that any or all of the components of hydropower system 10, such as fluid intake 12, first filter 14, fluid outlet 22, and/or second filter 24, may be adapted for use with any natural or man-made source and for other purposes such as flood control, irrigation, water supply, cooling water, etc. For example, fluid intake 12 and/or first filter 14 may be adapted to extract, gather, and/or receive fluid for use with a water drinking system, while fluid outlet 22 and/or second filter 24 may be adapted to disseminate fluid from such a system.

The disclosure set forth above encompasses multiple distinct inventions with independent utility. While each of these inventions has been disclosed in a preferred form or method, the specific alternatives, embodiments, and/or methods thereof as disclosed and illustrated herein are not to be considered in a limiting sense, as numerous variations are possible. The present disclosure includes all novel and non-obvious combinations and sub-combinations of the various elements, features, functions, properties, methods and/or steps disclosed herein. Similarly, where any disclosure above or claim below recites “a” or “a first” element, step of a method, or the equivalent thereof, such disclosure or claim should be understood to include one or more such elements or steps, neither requiring nor excluding two or more such elements or steps.

We claim:

1. A hydropower system for a body of water comprising:
a fluid intake positioned below a bed of the water body and immersed in a filter below the bed, wherein fluid flows from the water body through the filter into the fluid intake,
a tunnel with a first end in fluid communication with the fluid intake and a second end in fluid communication with a hydropower generator, and
a fluid outlet in fluid communication with the hydropower generator.

2. The hydropower system of claim 1, further comprising a valve connected between the fluid intake and the tunnel.

3. The hydropower system of claim 1, wherein the fluid intake includes a series of perforated pipes that each have a length between a first end and a second end in fluid communication with the tunnel, wherein the length of each pipe is immersed below the bed parallel relative to a current of fluid in the water body.

4. The hydropower system of claim 1, wherein the fluid flows substantially vertically through the filter at a velocity between about 0.03 feet per second and about 1.0 feet per second.

5. The hydropower system of claim 1, wherein the fluid flows from an underground water table through the filter into the fluid intake.

6. The hydropower system of claim 1, wherein the fluid intake includes:
a container with a downstream side positioned at a lower elevation than an upstream side, and a cavity with an open top, and
a raceway adjacent to and in fluid communication with the cavity, and
a catch basin in fluid communication with the raceway, positioned adjacent the downstream side, and opening into one or more collector pipes opening into the tunnel.

7. The hydropower system of claim 6, wherein the filter includes a gridded support above the open top of the container, a first filter layer on the gridded support and a second filter layer above the first filter layer.

8. The hydropower system of claim 7, further wherein the filter includes a filter blanket between the gridded support and the first filter layer.

9. The hydropower system of claim 7, wherein the second filter layer has a porosity and a permeability greater than a porosity and a permeability of the first filter layer.

10. The hydropower system of claim 1, wherein the fluid outlet includes at least one perforated pipe positioned below a bed of a body of water, immersed in an outlet filter below the bed.

11. The hydropower system of claim 10, wherein fluid flows from the at least one perforated pipe into a channel of the water body by flowing through the outlet filter at a substantially constant rate and substantially vertical relative to a current of fluid in the channel.

12. A hydropower system for a body of water comprising:
a fluid intake including one or more perforated pipes that can receive fluid from the water body through a filter positioned below a bottom of the water body, wherein fluid flows substantially vertically from the water body through the filter into the one or more perforated pipes,
one or more collector pipes in fluid communication with the one or more perforated pipes, and
a fluid conveyance structure in fluid communication at an upper end with the one or more collector pipes and at a lower end with a hydropower generator, enabling fluid to flow from the one or more perforated pipes through the one or more collector pipes into the fluid conveyance structure to generate electricity using the hydropower generator.

13. The hydropower system of claim 12, wherein the fluid conveyance structure is a tunnel.

14. The hydropower system of claim 12, wherein the filter is comprised of gravel.

15. The hydropower system of claim 12, wherein fluid flows substantially vertically through the filter at a velocity between about 0.3 feet per second and about 1.0 feet per second.

16. The hydropower system of claim 12, further comprising at least one fluid dissemination pipe immersed within a second filter below the bottom of a body of water that is in fluid communication with the hydropower generator.

17. A method for positioning a hydropower system in a natural streambed of a body of water, comprising the steps of:
excavating an upstream section and a downstream section of a natural streambed beneath a channel of the body of water,
positioning a fluid intake in the upstream section and a fluid outlet in the downstream section,
covering the fluid intake with a first filter and the fluid outlet with a second filter, wherein each filter has a predetermined permeability that is greater than a permeability of the natural streambed, and
interconnecting an elevated section of a tunnel to the fluid intake, a lower section of the tunnel to a hydropower generator, and the hydropower generator to the fluid outlet, enabling fluid to flow from the channel through the first filter into the fluid intake through the tunnel for use by the hydropower generator to generate power.

18. The method for positioning a hydropower system in a natural streambed of a body of water of claim 17, wherein the predetermined permeability of the first filter is different from the predetermined permeability of the second filter.

19. The method for positioning a hydropower system in a natural streambed of a body of water of claim 17, wherein fluid flows from the hydropower generator into the fluid outlet and exits into the channel through the second filter at a substantially constant rate, and substantially vertically relative to a current of fluid in the channel.

20. The method for positioning a hydropower system in a natural streambed of a body of water of claim 17, further comprising the steps of:
filling the upstream section with a first portion of the first filter before positioning the fluid intake in the upstream section, and
covering the fluid intake with a second portion of the first filter after positioning the fluid intake in the upstream section.
